(19) United States
(12) Patent Application Publication
(10) Pub. No.: US 2010/0238682 A1
(43) Pub. Date: Sep. 23, 2010

(54) HeadLyte safety device

(76) Inventor: Alan Ewald Carpenter, Windham, NH (US)

Correspondence Address: Alan E. Carpenter, 8 Glenwood Road, Windham, NH, 03087, US

(21) Appl. No.: 12/408,706

(22) Filed: Mar. 22, 2009

(51) Int. Cl. F21V 7/04; F21V 21/084

(52) U.S. Cl. 362/555; 362/105

(57) ABSTRACT

The “HeadLyte” Safety Device is intended to be attached or embedded within a helmet worn by a bicyclist, or, worn around the head of a walker or jogger. The “HeadLyte” is comprised of a band that is populated with light emitting devices providing 360 degrees of illumination. The purpose of this illumination is to alert other individuals and/or vehicles as to the presence and direction of travel of the person wearing the “HeadLyte”, The light emitting devices are connected to a power source and a microcontroller that enables them to flash in a variety of patterns. The light emitting devices may also utilize color to indicate direction of color. The increased visibility provided by the light emitting devices, combined with the location of the “HeadLyte” as it is worn at the highest possible point on the walker, jogger or bicyclist will further enhance the visibility of the wearer to others.

The invention is generally related to human powered transportation such as walkers and joggers, cyclists and individuals on roller blades or skateboards. Its purpose is to provide enhanced visibility for motorists and others who may come in contact with the user. The invention serves to alert other parties to the presence of the wearer of the invention. In addition, it may also inform them as to the wearer's direction of travel.

### BACKGROUND OF THE INVENTION

Historically, individuals on bicycles, or joggers, may have attached a red light to the rear of their bicycle or attire to alert approaching traffic of their presence. This light may blink or provide a steady beam.

Each year, thousands of cyclists, walkers and joggers are struck by a motor vehicle causing serious injury or death. Up to half of these accidents occur when they are struck by a vehicle that is approaching them from either the front or the side. For example, a bicyclist proceeding down a road is struck by an oncoming vehicle which makes a left turn into the path of the bicyclist. In many of these cases, low visibility is to blame.

Most of the remaining accidents occur when the individual jogger or bicyclist is struck from behind, usually due to a lack of visibility. Often times, the individual was illuminated from the rear. However, the proximity of the mounted tail light positioned it too low on their person or bicycle and an approaching motorist was unable to see them until they had passed the point where they could still avoid contact.

### BRIEF SUMMARY OF THE INVENTION

The invention will provide increased levels of safety to these pedestrians and cyclists by:
providing increased visibility due to the height of the illumination the invention provides
providing increased visibility due to sequential blinking
informing approaching traffic of the wearers direction of travel through use of safety-standard colors
providing increased visibility by providing 360 degrees of illumination

This is accomplished by providing a 360 degree, illuminated device to be worn on the head or helmet of the individual. This illumination, by being both visible from any direction and being worn at the highest possible point on the individual will provide enhanced visibility and hence, safety.

### DESCRIPTION OF THE DRAWINGS

FIG. 1:

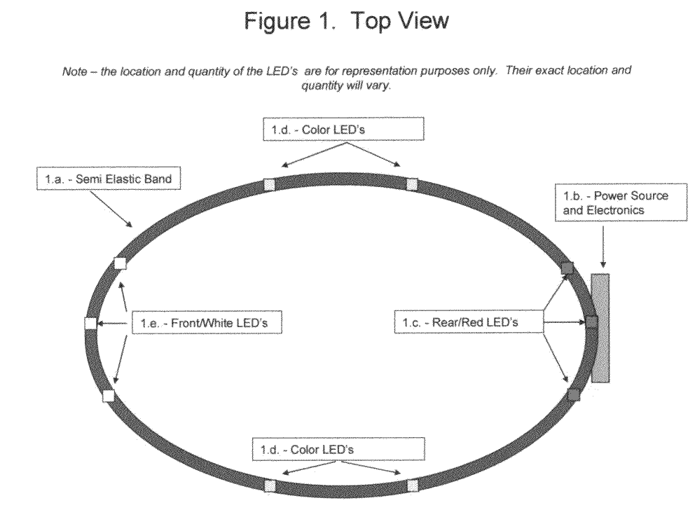

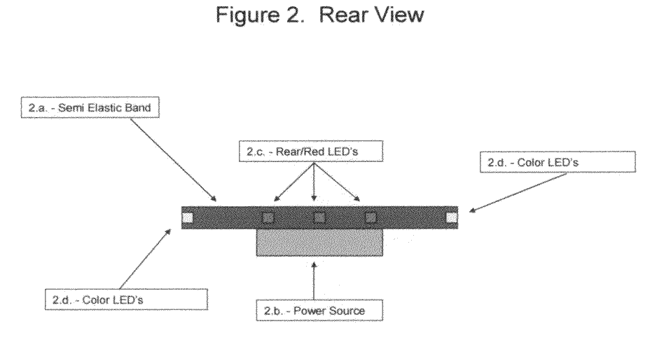

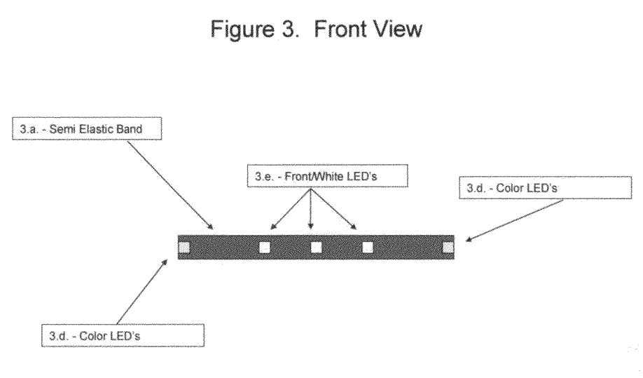

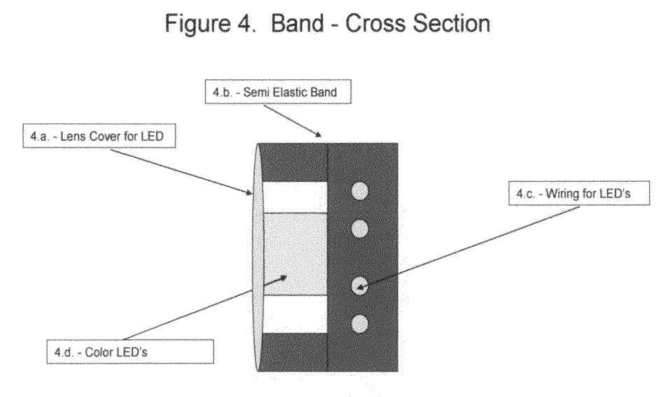

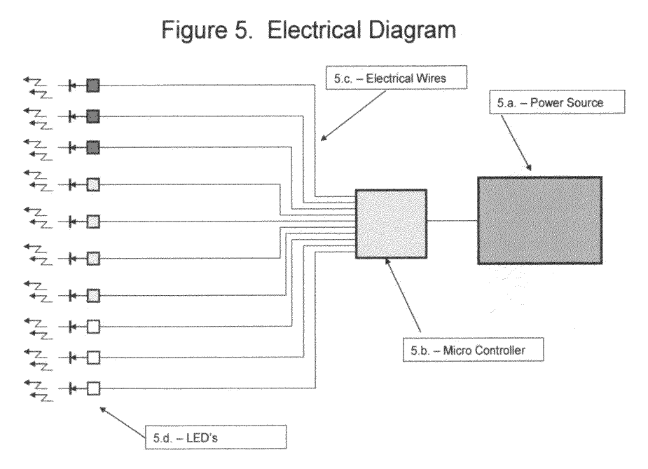

As viewed from above. The blue oval (FIG. 1.a) represents a band of plastic, or rubber, or like material that may be wrapped or covered in a different material for the purposes of aesthetics, comfort or functionality.

It may be affixed to a helmet through tension as a result of the band's elasticity, or it may be affixed to the helmet with an adhesive backing. It may also be incorporated into the design of the helmet.

Attached to, or embedded within the band are a series of Light Emitting Diodes or other light emitting devices (LED's). These LED's may be configured in a variety of patterns, rows, etc. The LED's mounted in the rear (FIG. 1.c) may be of a red color while the ones mounted on or near the front (FIG. 1.e) may be of a white or other color.

The LED's mounted on the sides and/or diagonal (FIG. 1.d) may be of a variety of colors.

The LED's are connected to a microchip via wires running through or attached to the band. This microchip is then connected to a power source (FIG. 1.b) This power source consists of a battery or batteries.

FIG. 2:

This is the invention as viewed from the rear. Visible are the side mounted LED's within the band. These may be yellow, orange or green in color.

FIG. 3:

This is the invention as viewed form the front. Visible here are the front mounted LED's. Generally, these will be white in color.

FIG. 4:

This is the invention as viewed in cross section. The band (FIG. 4.b) will also act as a foundation for the wires FIG. 4.c) that connect the LED's to the power source.

The LED (FIG. 4.d) may have a lens or protective cover (FIG. 4.a) over it. This cover may provide enhancement to the illumination qualities of the LED, this cover may provide protection for the LED, or both.

FIG. 5:

This is a schematic of the electronics of the invention.

Essentially, the power source provides power to the LED's via the microchip. The microchip controls the sequence of the LEDs' illumination. This sequence may be “all on”, “all blinking”, “partially on”, “partially blinking”, sequential or any combination thereof.

### DESCRIPTION OF THE INVENTION

A band constructed of firm or elastic material. This band is embedded with the appropriate wiring to connect a power source, a microchip or microcontroller and a multitude of light emitting diodes or other light emitting devices (LED's).

These lights are mounted on or within the band, and connected to the wiring constructed within the band. These wires are connected to a microchip or microcontroller that controls their illumination. Additional wiring connects the microchip/microcontroller to the power source.

These LED's are distributed around the circumference of the band. The band may:
be worn on the head of a person walking or jogging
be attached to an existing helmet through compression (hence the elasticity) or an adhesive
be embedded within a helmet during design and manufacture

The “HeadLyte” safety device is constructed by applying a multitude of light emitting devices (LED's) and associated wiring, power sources and controllers to an elastic band that can be attached to, worn on, or integrated into a safety helmet or individuals head.

These LED's will be arranged in a manner that allows them to be visible from any direction. They may flash or blink in a manner that increases their visibility to approaching motorists or other passers by.

Historically, bicyclists, joggers and the like have worn lights that are only visible from one direction, front or rear. In addition, these are most often worn in a low position, i.e. under the seat of a bicycle or on the belt of a jogger. The uniqueness of the HeadLyte lies in both its 360 degrees of visibility and its position on the individual, which is the highest point possible.

The controller may cause the lights to flash in a manner that is circular, sequential or all on, all off, etc. The controller may give the individual wearer the ability to select their method of illumination.

Additionally, by utilizing safety standard color conventions, one could potentially ascertain the direction of travel of the wearer by the color of the LED's as they approach.

1) A band (FIG. 1) to be affixed to a helmet of a person that is populated with LED's or other light emitting devices providing 360 degrees of illumination. These lights will vary in number, location and color. Some may be statically illuminated or they may be flashing or blinking. They will be distributed in a manner that allows another person or vehicle approaching the wearer to experience increased visibility of the wearer from any direction.

2) The band of claim 1 may be incorporated into a helmet during its design and subsequent construction.

3) A band to be worn on the head of a person that is populated with light emitting devices providing 360 degrees of illumination. These lights will vary in number, location and color. Some may be statically illuminated or they may be flashing or blinking. They will be distributed in a manner that allows another person or vehicle approaching the wearer; who may be walking, running, jogging, skate boarding or roller blading, to experience increased visibility of the wearer from any direction.

4) The band of claim 1, 2 and 3 may be constructed of a material sufficiently elastic (FIG. 1.a) to be stretched around the circumference of a helmet with adequate tension to ensure adherence to the helmet under normal and stressful circumstances or may be affixed by use of an adhesive.

5) The band of claim 1 and 3 may be coated with a light sensitive or reflective material to enhance illumination when bathed in artificial light.

6) The band of claim 1, 2 and 3 may have wiring or fiber optics attached to it, or embedded within it, (FIG. 4.c) for the purpose of connecting the power source to a multitude of light emitting devices attached to the band.

7) The band of claim 1, 2 and 3 may have a microchip/microcontroller attached to it (FIG. 5.b), for the purpose of controlling the illumination of the light emitting devices.

8) The power source (FIG. 1.b) attached to the band of claim 1, 2 and 3 may consist of permanent, removable, rechargeable and/or disposable batteries.

9) The light emitting devices (LED's) (FIG. 1.c.d.e.) of the band in claim 1, 2 and 3 may be light emitting diodes, incandescent bulbs or of an as yet known origin.

10) The light emitting devices of the band in claim 1, 2 and 3 may be configured in one or more rows around the circumference of the helmet, or traversing the crown of the helmet. Their pattern and groupings may vary.

11) The light emitting devices of the band in claim 1, 2 and 3 may be steadily illuminated or blinking or flashing a variety of colors.

12) The light emitting devices included in the band of claim 1, 2 and 3 may be covered by an individual lens, or a lens that covers a multitude of them. The lens may be for the purpose of protection, illumination, enhancement or other alteration of the light illuminating from the light emitting devices referenced in claim 1, 2 and 3.

13) The power source and microcontroller of the band of claim 2 may be integrated into the design and construction of the helmet.

14) The power source of the band of claim 2 may be a photo voltaic solar panel integrated into the surface of the helmet which incorporates the band.

15) The band of claim 3 may be constructed of a material sufficiently elastic to be stretched around the circumference of a persons head with adequate tension to ensure adherence to the person under normal and stressful circumstances.

16) The band of claim 3 may be constructed or lined with a material that is specifically intended to make the wearing of the band of claim 3 comfortable for the wearer, such as soft cloth and or padding.

17) The power source of the band of claim 3 may be a photo voltaic solar panel integrated onto the surface, such as the head, which is attached to the band.
